(19) United States
(12) Patent Application Publication
(10) Pub. No.: US 2008/0265870 A1
(43) Pub. Date: Oct. 30, 2008

(54) Particulate Matter Sensor

(76) Inventors: Balakrishnan G. Nair, Sandy, UT (US); Brett Henderson, Salt Lake City, UT (US)

Correspondence Address: CERAMATEC, INC., 2425 SOUTH 900 WEST, SALT LAKE CITY, UT, 84119, US

(21) Appl. No.: 12/111,080

(22) Filed: Apr. 28, 2008

Related U.S. Application Data
(60) Provisional application No. 60/914,634, filed on Apr. 27, 2007.

(51) Int. Cl. G01N 27/00; H01R 43/00

(52) U.S. Cl. 324/105; 29/592.1

(57) ABSTRACT

A sensor apparatus to burn off contaminating particulate matter from a sensor. The sensor apparatus includes a signal electrode assembly, a detector electrode assembly, and an electrical heater. The signal electrode assembly includes a signal electrode coupled to a signal electrode insulating substrate. The detector electrode assembly includes a detector electrode coupled to a detector electrode insulating substrate. The detector electrode is positioned relative to the sensor electrode to generate a measurement of an ambient condition. The electrical heater is positioned relative to the signal and detector electrode assemblies to burn off an accumulation of contaminating particles from at least one electrode assembly of the signal and detector electrode assemblies.

### CROSS-REFERENCE TO RELATED APPLICATIONS

This application claims the benefit of U.S. Provisional Application No. 60/914,634, filed on Apr. 27, 2007, which is incorporated by reference herein in its entirety.

### BACKGROUND

Internal combustion engines (e.g., diesel engines) typically generate an exhaust flow that contains varying amounts of particulate matter (PM). The amount and size distribution of particulate matter in the exhaust flow tends to vary with engine operating conditions, such as fuel injection timing, injection pressure, or the engine speed to load relationship. Adjustment of these conditions may be useful in reducing particulate matter emissions and particulate matter sizes from the engine. Reducing particulate matter emissions from internal combustion engines is environmentally favorable. In addition, particulate matter measurements for diesel exhaust is useful for on-board (e.g., mounted on a vehicle) diagnostics of PM filters and reduction of emissions through combustion control.

Conventional technologies typically involve the deposition of a particulate matter layer onto a wire or electrode and monitor the change in some property of the wire of electrode such as its electrical conductivity or mass. The problem with these approaches is that they are not sensitive to real time changes. These approaches measure the history of particle deposition and not real time changes in the particulate matter.

These versions also suffer in that particulate matter buildup decreases the sensitivity of the device over time. Some sensors may incorporate a heater to burn off particulate matter from the electrode, however, these versions cannot continuously burn off the particulate matter because they require a layer of particulate matter for operation. Thus, they are always susceptible to decreases in sensitivity.

One alternative to devices that require a particulate matter layer buildup for operation is a high voltage sensor using metallic electrodes such as wires or rods. The disadvantages of these types of sensors are that metallic electrodes by their nature can bend or flex due to vibration for example which causes signal variation because the signal is function of the electrode distance and the movable electrodes causes “signal noise” which adversely affects sensitivity and accuracy. Another problem with wire electrodes is that if they move and touch due to vibrations or other reasons, the sensor will short out.

Thus it would be an advancement to have a sensor that does not require particulate matter layer buildup for operation. It would be another advantage to be able to have device where the electrodes are fixed and can be placed close together without reduced fear of shorting the sensor.

### SUMMARY

Embodiments of an apparatus are described. In one embodiment, the apparatus is a sensor apparatus to burn off contaminating particulate matter from a sensor. One embodiment of the sensor apparatus includes a signal electrode assembly, a detector electrode assembly, and an electrical heater. The signal electrode assembly includes a signal electrode coupled to a signal electrode insulating substrate. The detector electrode assembly includes a detector electrode coupled to a detector electrode insulating substrate. The detector electrode is positioned relative to the sensor electrode to generate a measurement of an ambient condition. The electrical heater is positioned relative to the signal and detector electrode assemblies to burn off an accumulation of contaminating particles from at least one electrode assembly of the signal and detector electrode assemblies. Other embodiments of the apparatus are also described.

Embodiments of a method are also described. In one embodiment, the method is a method of using a sensor apparatus to burn off contaminating particulate matter from a sensor. One embodiment of the method includes sensing an ambient condition with a signal electrode assembly and a detector electrode assembly. The signal electrode assembly includes a signal electrode coupled to a signal ceramic substrate. The detector electrode assembly includes a detector electrode coupled to a detector ceramic substrate. The method also includes supplying power to a heater positioned relative to at least one electrode assembly of the signal and detector electrode assemblies. The method also includes heating one or more of the signal and detector electrode assemblies to a temperature greater than a burn threshold of a contaminating particulate matter on the one or more of the signal and detector electrode assemblies. Other embodiments of the method of use are also described.

Embodiments of a method for making a sensor apparatus to burn off contaminating particulate matter from a sensor are also described. In one embodiment, the method includes coupling a signal electrode to a signal electrode insulating substrate to form a signal electrode assembly. The method also includes coupling a detector electrode to a detector electrode insulating substrate to form a detector electrode assembly. The detector electrode is positioned relative to the signal electrode to generate a measurement of an ambient condition. The method also includes positioning a heater relative to the signal and detector electrode assemblies to burn off an accumulation of contaminating particulate matters from at least one electrode assembly of the signal and detector electrode assemblies. Other embodiments of the method of fabrication are also described.

Embodiments of a system are also described. In one embodiment, the system is a sensing system to measure particulate matter. One embodiment of the sensing system includes a sensor element, a heater, and an electronic control module. The sensor element includes a signal electrode assembly and a detector electrode assembly. The signal electrode assembly includes a signal electrode coupled to a signal electrode insulating substrate. The detector electrode assembly includes a detector electrode coupled to a detector electrode insulating substrate. The detector electrode is configured in combination with the signal electrode to generate an electrical signal in response to detection of particulate matter in a passing airstream. The heater is positioned relative to the sensor element to burn off an accumulation of contaminating particulate matters on the sensor element. The electronic control module is coupled to the heater to regulate a temperature of the heater relative to a burn threshold of the contaminating particulate matters on the sensor element. Other embodiments of the system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of an electrode assembly.

FIG. 2 depicts a schematic diagram of one embodiment of a heater assembly.

FIG. 3 depicts a schematic diagram of a combined electrode and heater assembly.

FIG. 4 depicts a schematic diagram of one embodiment of a particulate matter sensor assembly.

FIG. 5 depicts a schematic diagram of another embodiment of a particulate matter sensor assembly.

FIG. 6 depicts a schematic diagram of another embodiment of a particulate matter sensor assembly.

FIG. 7 depicts a schematic diagram of another embodiment of a particulate matter sensor assembly.

FIG. 8 depicts a schematic diagram of one embodiment of a particulate matter sensor.

FIG. 9 depicts a schematic block diagram of one embodiment of a particulate matter measurement system.

FIG. 10 depicts a schematic flowchart diagram of one embodiment of a method for operating a particulate matter sensor.

FIG. 11 depicts a schematic flowchart diagram of one embodiment of a method for fabricating a particulate matter sensor.

Throughout the description, similar reference numbers may be used to identify similar elements.

### DETAILED DESCRIPTION

In the following description, specific details of various embodiments are provided. However, some embodiments may be practiced without at least some of these specific details. In other instances, certain methods, procedures, components, and circuits are not described in detail for the sake of brevity and clarity.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In general, the described embodiments are directed to methods and devices for reducing performance degradation due to deposition or accumulation of carbonaceous and other combustible or volatile materials on a particulate matter (PM) sensor. Particulate matter sensors based on the measurement of static accumulated charge or current measurement with a high voltage bias can be affected by the deposition of such species. Embodiments of the PM sensor described herein are closely coupled with a heater that can continuously or periodically burn off or otherwise remove the combustible or volatile species. In one embodiment, such heaters can be on a substrate that also contains or is proximate to the signal and/or detector electrodes. For convenience, the present description refers to the signal and detector electrodes, although other terminology such as sensing and detection electrodes may be used to reference the same or similar electrodes.

Additionally, some embodiments implement an increased effective area of the electrode in order to maximize or otherwise improve the signal through a thick film or thin film fabrication approach. The thick film fabrication approach can include, but is not limited to, screen printing, sputtering, etc. The thin film approach can include, but is not limited to, vacuum deposition techniques such as chemical and physical vapor deposition. In some embodiments, the PM sensor is packaged in a metal housing which can be mounted within an exhaust gas environment, or another environment where measurement of particulate matter can be obtained. Also, some embodiments implement a method of measuring or monitoring particulate matter in an exhaust gas or other environment where measurement of particulate matter can be obtained.

The basic configuration of at least one embodiment of the PM sensor includes a two electrode structure containing a signal electrode and a detector electrode. A high voltage is applied to the signal electrode and, under the application of this voltage, the particulate matter can be measured either by measuring the charge that accumulates on the detector electrode. Alternatively, the particulate matter can be measured by measuring an output voltage generated by the accumulated charge.

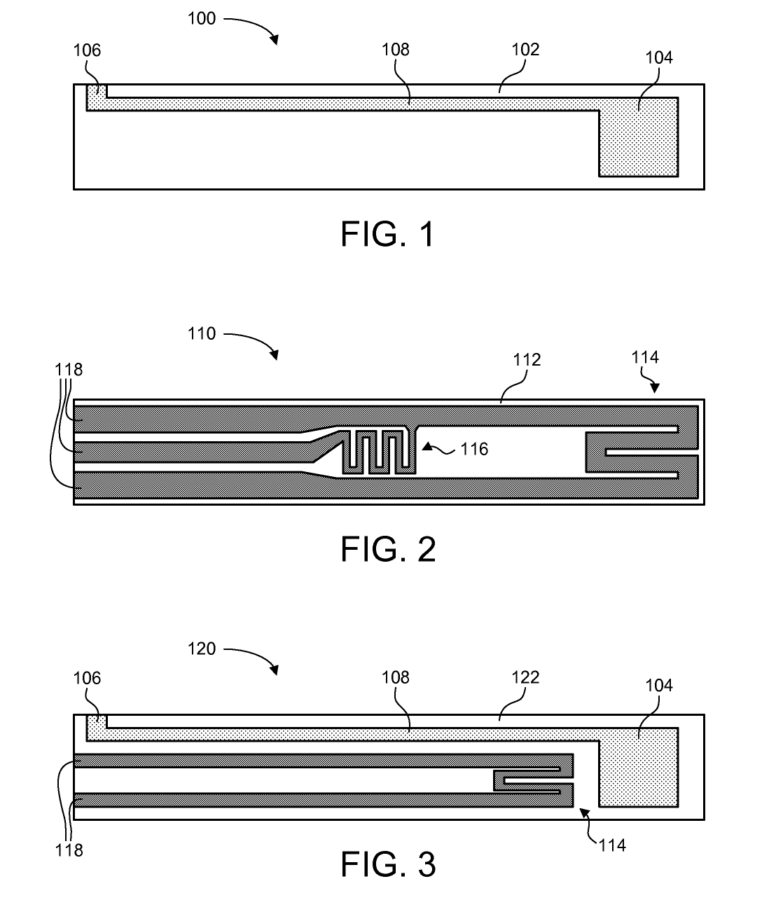

FIG. 1 depicts a schematic diagram of one embodiment of an electrode assembly 100. The illustrated electrode assembly 100 is representative of either of the signal electrode or the detector electrode within a sensor element. The depicted electrode assembly 100 includes an insulating substrate 102 with a conductive layer applied to at least one surface of the insulating substrate 102. For convenience, the insulating substrate 102 is referred to as a signal electrode insulating substrate when the conductive layer is used to implement a signal electrode. Alternatively, the insulating substrate 102 is referred to as a detector electrode insulating substrate when the conductive layer is used to implement a detector electrode. However, this terminology is not limiting to the configuration of the electrode assembly 100.

The conductive layer applied to the surface of the insulating substrate 102 includes an electrode 104, an electrode contact 106, and an electrode trace 108 connecting the electrode 104 to the electoral contact 106. In general, the electrode 104 is used in conjunction with another electrode of another correspondent electrode assembly to detect particulate matter in the surrounding environment such as an exhaust stream. The electrode trace 108 carries an electrical signal (e.g., a charge, current, or voltage) to the electrode contacts 106, which facilitates an electrical connection to a controller or other device. In one embodiment, the conductive layer is formed of platinum (Pt). Other embodiments may use other conductive materials.

The electrode assembly 100 may be fabricated using any suitable method. In some embodiments, the substrate 102 is a ceramic substrate such as alumina. In some embodiments, the substrate 102 is a ceramic coating or layer it is deposited on another ceramic material. Alternatively, the ceramic coating or layer may be deposited on any metal material or on a high-temperature polymer layer. For example, the metal materials may include stainless steel, nickel-based super alloys or similar materials. The high-temperature polymer layers may include thermoplastic or similar materials.

The conductive layer of the electrode assemblies 100 also may be fabricated using any suitable technology. In some embodiments, the conductive trace may be applied to the surface of the electrode substrate 102 using a thick film fabrication, or formation, method. Some examples of thick film fabrication methods include screen printing and sputtering, although other thick film fabrication methods may be used. In some embodiments, the conductive trace may be applied to the surface of the electrode substrate 102 using a thin film fabrication, or formation, the method. Some examples of thin film fabrication methods include vacuum deposition techniques such as chemical and physical vapor deposition, although other thin film fabrication methods may be used. By using a thick or thin film fabrication method, the effective area of the electrode 104 may be relatively large in order to provide a relatively strong electrical signal.

FIG. 2 depicts a schematic diagram of one embodiment of a heater assembly 110. In many aspects, the heater assembly 110 is similar to the electrode assembly 100 of FIG. 1, although the heater assembly 110 is generally used to generate heat, rather than to obtain an electrical signal. The illustrated heater assembly 110 includes a heater substrate 112, multiple heaters 114 and 116, and corresponding heater contacts 118. It should be noted that, although multiple heaters 114 and 116 are shown in the illustrated heater assembly 110, other embodiments of the heater assembly 110 may include a single heater, more than one heater, or other quantities and/or arrangements of heaters.

Similar to the electrode assembly 100 described above, the heater assembly 110 may be formed using a thick or thin film fabrication methods to form conductive traces on a ceramic or otherwise insulating substrate 112. Additionally, the implementation of one or more heaters 114 and 116 on the heater assembly 110 does not preclude the use of additional heaters such as a separate coil, planar, or other heater.

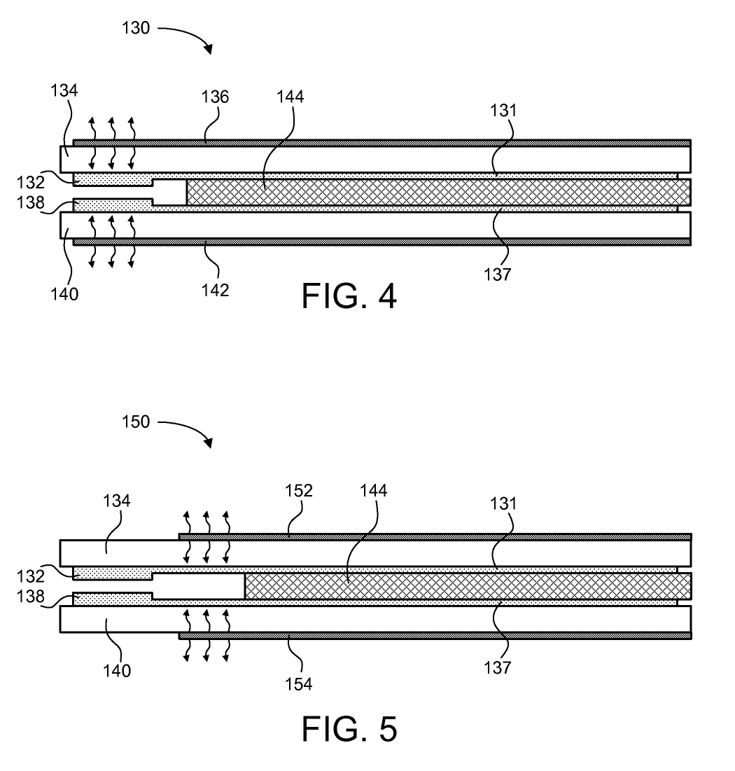

In some embodiments, the electrode substrate 102 and the heater substrate 112 may be the same substrate. For example, the conductive traces for the electrode assembly 100 may be applied to one side of a common substrate, while the conductive traces for the heater assembly 110 may be applied to the opposite side of the same substrate (refer to FIGS. 4 and 5). Alternatively, in some embodiments, the conductive traces for the electrode assembly 100 and the heater assembly 110 may be applied to the same side of a common substrate. FIG. 3 depicts a schematic diagram of a combined electrode and heater assembly 120. The illustrated assembly 120 includes conductive traces for both electrode and heater assemblies on the same side of a common substrate 122.

FIG. 4 depicts a schematic diagram of one embodiment of a particulate matter sensor assembly 130. The illustrated particulate matter sensor assembly 130 includes a combination of electrode and heater assemblies which are similar to the electrode assembly 100 of FIG. 1 and the heater assembly 110 of FIG. 2. In particular, the particulate matter sensor assembly 130 includes a signal electrode assembly 137 and a detector electrode assembly 137. The signal electrode assembly 137 includes a signal electrode 132 applied to a signal electrode insulating substrate 134. The signal electrode assembly 137 also includes a heater 136 applied to the back side of the signal electrode insulating substrate 134. Similarly, the detector electrode assembly 137 includes a detector electrode 138 applied to a detector electrode insulating substrate 140, with a heater 142 applied to the back side of the detector electrode insulating some straight 140.

The signal electrode assembly 137 and the detector electrode assembly 137 are separated by an insulating spacer 144 or by another mechanical separator. In some embodiments, the insulating spacer 144 and the physical configuration of the signal and detector electrode assemblies results in a very small distance between the signal electrode 132 and the detector electrode 138. As one example, the distance between the signal and detector electrodes 132 and 138 may be as small as approximately 1 μm. Alternatively, the distance between the signal and detector electrodes 132 and 138 may be as large as 1 cm. In one embodiment, the distance between the signal electrode 132 and the detector electrode 138 is within a range of about 0.5-2.0 mm. Other embodiments may implement other distances between the signal and detector electrodes 132 and 138.

In some embodiments, the insulating substrates 134 and 140 may be bonded to the insulating spacer 144. The bonding may be implemented by sintering the layers together, or by using another bonding method. In embodiments in which the layers are sintered together, the signal and detector electrodes 132 and 138 may be applied before or after the sintering process. The bonding methods for bonding the spacer 144 to the substrates 134 and 140 may also include glass bonding, metallization bonding, or mechanical bonding such as clamping or wire tying to name a few. It will be appreciated by those of skill in the art that these and other bonding methods may also be used for bonding other components of the various assemblies discussed herein.

FIG. 4 also depicts several arrows to illustrate heat transfer from the heaters 136 and 142 to the signal and detector electrodes 132 and 138, respectively. The depicted arrows illustrate the approximate location of the heater or heater arrangements 114 (refer to FIG. 2) on the heater layers 136 and 142. In the illustrated embodiment, the heater arrangements 114 are approximately aligned with the signal and detector electrodes 132 and 138. In this way, the heater arrangements 114 generally transfer heat toward the signal and detector electrode 132 and 138, rather than toward the electrode traces 108 (refer to FIG. 1) in the regions adjacent to the signal and detector electrodes 132 and 138.

FIG. 5 depicts a schematic diagram of another embodiment of a particulate matter sensor assembly 150. The illustrated particulate matter sensor assembly 150 is substantially similar to the particulate matter sensor assembly 130 of FIG. 4, except that the heaters 136 and 142 are arranged to transfer heat toward regions adjacent to the signal and detector electrodes 132 and 138, rather than directly toward the signal and detector electrodes 132 and 138. In other words, the heaters 136 and 142 are implemented to burn off particulate matter from the electrode traces 108 (refer to FIGS. 1 and 3), rather than directly from the signal and detector electrodes 132 and 138.

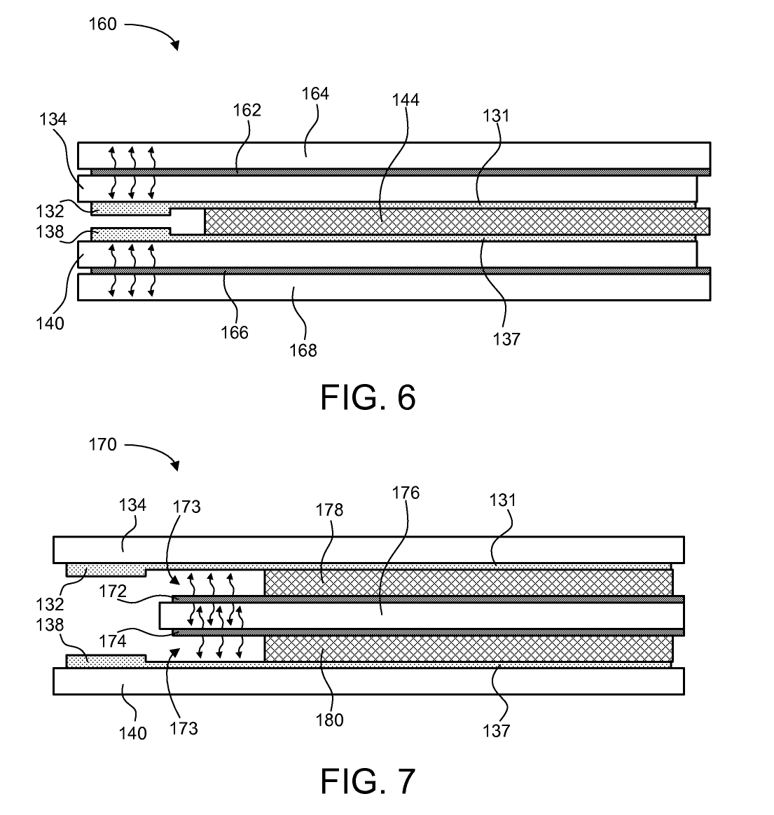

FIG. 6 depicts a schematic diagram of another embodiment of a particulate matter sensor assembly 160. The illustrated particulate matter sensor assembly 160 is substantially similar to the particulate matter sensor assembly 130 of FIG. 4, except that the heaters 162 and 166 are applied to separate heater substrates 164 and 168, respectively. In this way, the heater assemblies may be fabricated separately from the electrode assemblies and subsequently bonded or otherwise attached to the electrode assemblies using bonding methods discussed above. Although the illustrated embodiment includes heaters 162 and 166 which direct heat towards the signal and the detector electrodes 132 and 138, other embodiments may implement heaters similar to the heaters 136 and 142 shown in FIG. 5 which direct heat toward the regions approximately adjacent to the signal and detector electrodes 132 and 138.

FIG. 7 depicts a schematic diagram of another embodiment of a particulate matter sensor assembly 170. In contrast to the particulate matter sensor assemblies described above with reference to FIGS. 4-6, the particulate matter sensor assembly 170 illustrated in FIG. 7 implements heaters 172 and 174 on a heater substrate 176 between a signal electrode assembly 137 and the detector electrode assembly 137. Hence, multiple insulating spacers 178 and 180 are used to insulate the signal electrode assembly 137 and the detector electrode assembly 137, respectively, from the intermediate heater assembly. Also, in the illustrated embodiment, the insulating spacers 178 and 180 are offset relative to the heaters 172 and 174. The offset creates a gap 173 that separates the heaters 172 and 174 from the respective electrodes 132 and 138 and any lead wires connected to the electrodes. This may be advantageous in the case where increased electrical conductivity occur in ceramic materials at elevated temperatures due to the presence of a small amounts of impurity in the ceramic material, such as transition metal oxides or alkali metal oxides. By providing a gap 173, electrical interference between the heater and either sensing or detection electors as well as the respective lead wires is reduced. The gap 173 may be space, or a high purity spacer. In some embodiments, using a gap 173 is more cost effective than using spacer material with a sufficiently high purity to avoid increased electrical conductivity.

In one embodiment, a sensor assembly or apparatus may include a signal electrode assembly with a signal electrode coupled to a signal electrode insulating ceramic substrate. It may also include a detector electrode assembly comprising a detector electrode coupled to a detector electrode insulating ceramic substrate, wherein the detector electrode is positioned relative to the signal electrode to generate a measurement of an ambient condition. The apparatus may be without a heater or heater assembly, but may have a voltage supply in communication with at least one of the signal and detector electrodes, wherein the voltage supply is configured to apply a bias voltage to one of the signal and detector electrodes. The bias voltage may comprise a voltage within a range of approximately 50 to 10,000 Volts relative to the other electrode of the signal and detector electrodes. In one embodiment, the bias voltage by be within a range of 100 to 2,000 Volts.

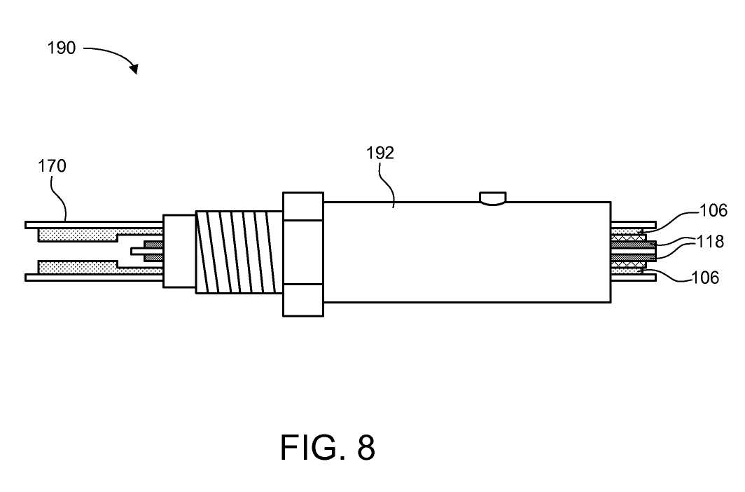

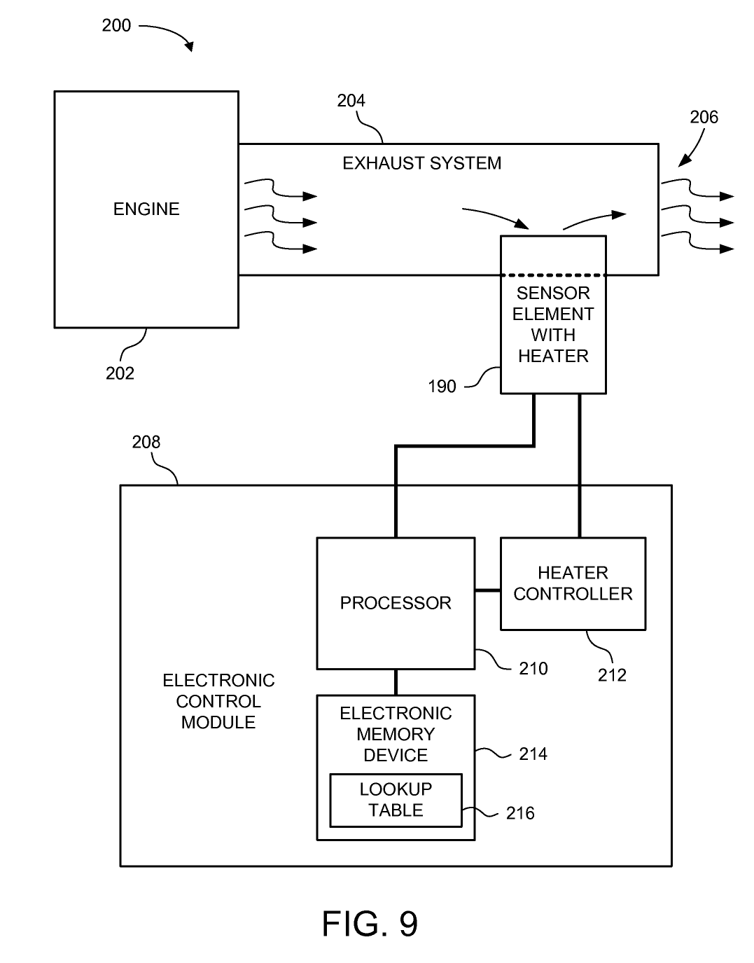

FIG. 8 depicts a schematic diagram of one embodiment of a particulate matter sensor 190. The illustrated particulate matter sensor 190 implements the particulate matter sensor assembly 170 of FIG. 7 within a housing 192. Other embodiments may use other particulate matter sensor assemblies, as described above. In one embodiment, the housing 192 is a metal housing or another type of housing which offers environmental protection and structural support for the particulate matter sensor assembly 170. In general, the housing 192 facilitates mounting the particulate matter sensor assembly 170 in an exhaust gas environment or other environment where measurement a particulate matter can be obtained. For example, the housing 192 may include a threaded neck to facilitate placing the particulate matter sensor 190 into a corresponding threaded hole in an exhaust gas system (refer to FIG. 9). When mounted in an exhaust gas system, the signal and detector electrodes 132 and 138 are exposed to a passing airstream such as an exhaust gas stream. Hence, the particulate matter sensor assembly 170 is able to measure concentrations of particulate matter in the exhaust gas stream.

In one embodiment, the housing 192 of the particulate matter sensor 190 allows the electrode contacts 106 and the heater contacts 118 to be exposed for electrode connections to a controller or other electronic device (refer to FIG. 9). In some embodiments, the housing 192 may be configured to fully enclose a connection end of the particulate matter sensor assembly 170 and to allow connecting wires to pass through an aperture in the housing 192.

FIG. 9 depicts a schematic block diagram of one embodiment of a particulate matter measurement system 200. The illustrated particulate matter measurement system 200 includes an engine 202 and an exhaust system 204. The exhaust system 204 is connected to the engine 202, which produces exhaust gases. The exhaust system 204 facilitates flow of the exhaust gases to an exhaust outlet 206.

In order to control particulate matter emissions from the engine 202, or to otherwise monitor particulate matter levels in the exhaust gas stream, the sensor element 190 measures concentrations of particulate matter, as described above. Since an accumulation of particulate matter on the signal and detector electrodes 132 and 138 of the sensor element 190 may degrade the performance of the sensor element 190, the sensor element 190 includes one or more heaters to burn off combustible particulate matters that accumulate on or near the signal and detector electrodes 132 and 138. Some embodiments of the particulate matter measurement system 200 also may include one or more emissions control elements to emit neutralizing chemicals into the exhaust system 204 either before or after the sensing element 190.

The sensor element 190 is in electronic communication with an electronic control module 208. In general, the electronic control module 208 generates measurements of the particulate matter levels in the exhaust system 204. The measurements may be proportional or otherwise correlated with the signal levels generated by the sensor element 190. The electronic control module 208 also controls the operation of the heaters 172 and 174 within the sensor element 190. The electronic control module 208 also converts the input voltage supply, which may be from an direct current power source, (typically around 9 to 24 V), to a higher voltage supply utilized by the sensor element 190. In one embodiment, the sensor element 190 may utilize a voltage supply up to about 10,000 V. In another embodiment, the voltage supply may be in the range of 500 to 5,000 V. In another embodiment, the voltage supply may be in the range of 100 to 2,000 V.

The illustrated electronic control module 208 includes a processor 210, a heater controller 212, and an electronic memory device 214. The sensor element 190 communicates one or more electoral signals to the processor 210 of the electronic control module 208 using any type of data signal, including wireless and wired data transmission signals.

In one embodiment, the processor 210 facilitates execution of one or more operations of the particulate matter measurement system 200. In particular, the processor 210 may execute instructions stored locally on the processor 210 or stored on the electronic memory device 214. Additionally, various types of processors 210, include general data processors, application specific processors, multi-core processors, and so forth, may be used in the electronic control module 208.

In some embodiments, the processor 210 also generates a voltage bias for supply to the sensor element 190. The voltage bias facilitates increasing a voltage level of the least one of the electrodes relative to the other electrode. In one embodiment, the voltage bias may be in the range of approximately 1-10,000 V. As a more specific example, the voltage bias may be in the range of approximately 500-5,000 V. Other embodiments may use other voltage bias parameters.

In some embodiments, the processor 210 may reference a lookup table 216 stored in the electronic memory device 214 in order to generate a measurement of the concentration of particulate matter within the exhaust system 204. Other embodiments may use other methods to correlate signal levels of the sensor element 190 with particulate matter measurement levels.

In one embodiment, the heater controller 212 controls the heater or heaters in the sensor element 190 to maintain specific operating temperatures for the corresponding electrode assemblies and, in particular, the corresponding sensor electrodes. The heater controller 212 may operate the heaters of the sensor element 190 continuously, periodically, or on some other non-continuous basis. In one embodiment, the heater controller 212 operates the heaters at or above a temperature of approximately 200° C. In some embodiments, the heater controller 212 operates the heaters at or above a temperature of approximately 400° C. Other embodiments may operate the heaters at other temperatures.

It should also be noted that the sensor element 190 may be used, in some embodiments, to determine a failure in a particulate matter sensor assembly or in another component of the particulate matter measurement system 200. For example, the sensor element 190 may be used to determine a failure of a particulate matter filter (not shown) within the exhaust system 204. In one embodiment, a failure within the particulate matter measurement system 200 may be detected by an elevated signal generated by the sensor element 190.

It should also be noted that embodiments of the particulate matter sensor assembly may be tolerant of fluctuations of certain gaseous constituents in an exhaust gas environment. In this way, the particulate matter sensor assembly may be calibrated to measure particular chemicals or materials within an exhaust gas environment.

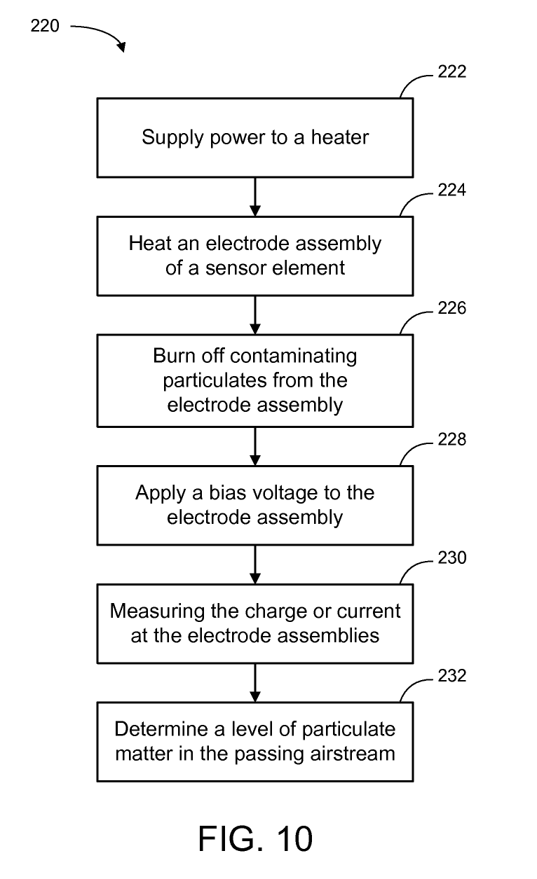

FIG. 10 depicts a schematic flowchart diagram of one embodiment of a method 220 for operating a particulate matter sensor. While certain particulate matter sensors and particulate matter sensor assemblies may be referenced in connection with the description of the method 220, embodiments of the method 220 may be implemented with other types of particulate matter sensors and particulate matter sensor assemblies. Additionally, embodiments of the method 220 may be implemented with various types of particulate matter measurement systems.

In the illustrated embodiment, an electronic control module activates a heater controller to supply 222 power to a heater in a sensor element. As the heater or heaters in the sensor element increase in temperature, the corresponding portions of the electrode assemblies are also heated 224. By raising the temperatures sufficiently, the heaters burn off 226 contaminated particulate matters from the electrode assemblies. After the particulate matters are completely or partially burned off of the electrode assemblies, or even during the burn-off process, the processor applies 228 a bias voltage to at least one of the electrode assemblies. The processor then measures 230 a charge or current generated at the electrode assemblies and determines 232 the level of particulate matter in the passing exhaust stream. As mentioned above in connection with FIG. 9, the processor may refer to a lookup table or other data stored in an electronic memory device in order to determine a level of particulate matter corresponding to the electrical signal received from the sensor element. The depicted method 220 then ends.

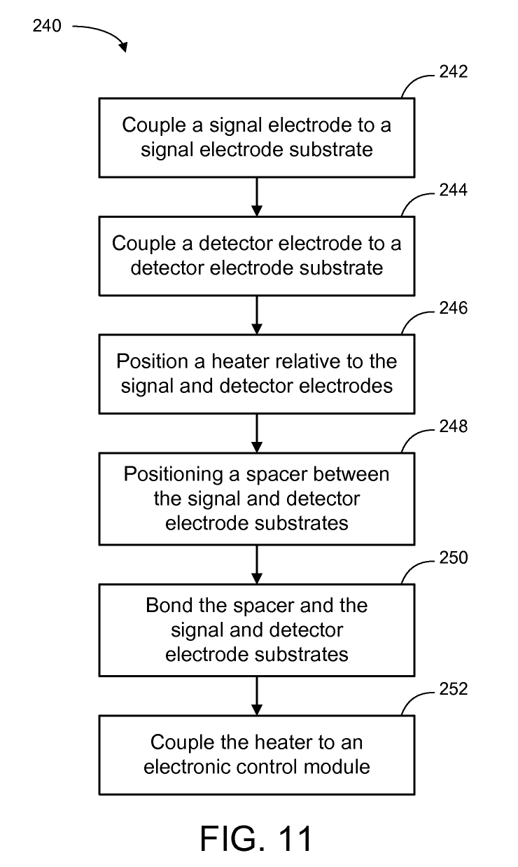

FIG. 11 depicts a schematic flowchart diagram of one embodiment of a method 240 for fabricating a particulate matter sensor. While certain particulate matter sensors and particulate matter sensor assemblies may be referenced in connection with the description of the method 240, embodiments of the method 240 may be implemented with other types of particulate matter sensors and particulate matter sensor assemblies. Additionally, embodiments of the method 240 may be implemented with various types of particulate matter measurement systems.

In the illustrated embodiment, a particulate matter sensor 190 is fabricated by coupling 242 a signal electrode to a signal electrode substrate. A detector electrode is also coupled 244 to a detector electrode substrate. A heater is then positioned 246 relative to the signal and detector electrodes. Also, any insulating spacers used for insulating and/or spacing functionality are positioned 248 between the signal and detector electrode substrates. The signal and detector electrode substrates are then bonded 250 to any spacers, and the heater is coupled 252 to an electronic control module. Various other fabrication techniques, as explained above or as understood in light of the present specification, may be taken into consideration and implemented to fabricate one or more embodiments of the particulate matter sensor. The depicted fabrication method 240 then ends.

In one embodiment of the method 240, a PM sensor includes two platinum (Pt) electrodes acting as a signal electrode and a detector electrode, printed (242 and 244) on corresponding alumina substrates. The substrates are arranged so that the Pt electrodes are facing each other and are closely spaced 248, but electrically isolated. A Pt heater is printed 246 on the back side of each substrate (i.e., the opposite sides from the electrodes). These heaters facilitate regeneration (e.g., thermally enhanced oxidation of carbonaceous particulate matters). In one embodiment, these two identical alumina elements are then assembled in a stainless steel housing and cemented. It will be appreciated by those of skill in the art that other electrically conductive electrodes may be used 250.

As a further, non-limiting example, a Pt heater may be screen-printed 242 or 244 on a substrate. In one embodiment, a Pt ink (e.g., Heraeus, 5100) is screen-printed on an alumina substrate which is approximately 8 0.5 cm×1.1 cm×0.1 cm. The screen-printed structure is then baked at 1000° C. for about one hour, with a three hour ramp. In some embodiments, the same ink is subsequently printed again on top of the and sintered at 1200° C. for about one hour, with a three hour ramp.

As another, non-limiting example, a Pt electrode may be screen-printed on a substrate. In one embodiment, a rectangular Pt electrode of approximately 0.7 cm×0.7 cm is prepared by screen-printing a Pt ink (Heraeus, 5100) on the backside of the heater described above. The electrode structure is then sintered at 1000° C. for about 0.5 hours, with a five hour ramp.

After fabricating two symmetrical electrode assemblies, as described above, that can function as the sensor and detection electrode assemblies respectively, the symmetrical electrode assemblies are combined with an alumina spacer inserted 248 between the two electrode assemblies. The electrode assemblies are further arranged facing each other, as described above. The resulting configuration is then put into a stainless steel sensor housing, with at least a portion of the electrodes exposed from the housing. This allows the electrodes to be exposed to a gas stream flowing past the housing. In some embodiments, at least some of the space remaining in the housing is filled with a high temperature cement. Additionally, as described above, the electrical contacts for the sensor assembly are accessible at the opposite end of the housing.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A sensor apparatus comprising:
a signal electrode assembly comprising a signal electrode coupled to a signal electrode insulating substrate;
a detector electrode assembly comprising a detector electrode coupled to a detector electrode insulating substrate, wherein the detector electrode is positioned relative to the signal electrode to generate a measurement of an ambient condition; and
a first electrical heater positioned relative to the signal and detector electrode assemblies to burn off an accumulation of contaminating particulate matters from at least one electrode assembly of the signal and detector electrode assemblies.

2. The sensor apparatus of claim 1, wherein the signal and detector electrodes are further configured to detect a particulate matter.

3. The sensor apparatus of claim 1, wherein at least one insulating substrate of the signal and detector electrode insulating substrates comprises a ceramic substrate.

4. The sensor apparatus of claim 1, wherein at least one insulating substrate of the signal and detector electrode insulating substrates comprises a ceramic coating and a high temperature polymer layer.

5. The sensor apparatus of claim 1, further comprising an insulting spacer between the signal and detector electrode assemblies.

6. The sensor apparatus of claim 5, further comprising a second electrical heater positioned relative to the signal and detector electrode assemblies, wherein the first electrical heater comprises a signal electrode heater located on the signal electrode insulating substrate of the signal electrode assembly opposite the signal electrode, and wherein the second electrical heater comprises a detector electrode heater located on the detector electrode insulating substrate of the detector electrode assembly opposite the detector electrode.

7. The sensor apparatus of claim 6, wherein the signal and detector electrode heaters are approximately aligned with the signal and detector electrodes of the signal and detector electrode assemblies.

8. The sensor apparatus of claim 5, further comprising:
a signal electrode heater substrate, wherein the first electrical heater comprises a signal electrode heater coupled to the signal electrode heater substrate, wherein the signal electrode heater and the signal electrode heater substrate are bonded to the signal electrode insulating substrate of the signal electrode assembly.

9. The sensor apparatus of claim 8, further comprising:
a second electrical heater comprising a detector electrode heater; and
a detector electrode heater substrate, wherein the detector electrode heater and the detector electrode heater substrate are bonded to the detector electrode insulating substrate of the detector electrode assembly.

10. The sensor apparatus of claim 1, further comprising a heater substrate between the signal and detector electrode assemblies.

11. The sensor apparatus of claim 10, further comprising a second electrical heater positioned relative to the signal and detector electrode assemblies, wherein the first electrical heater comprises a signal electrode heater located on a signal electrode side of the heater substrate, and wherein the second electrical heater comprises a detector electrode heater located on a detector electrode side of the heater substrate opposite the signal electrode heater.

12. The sensor apparatus of claim 11, further comprising:
a first spacer between the signal electrode heater and the signal electrode assembly to insulate the signal electrode assembly from the signal electrode heater; and
a second spacer between the detector electrode heater and the detector electrode assembly to insulate the detector electrode assembly from the detector electrode heater.

13. The sensor apparatus of claim 12, wherein the signal and detector electrode heaters are approximately aligned with the signal and detector electrodes of the signal and detector electrode assemblies.

14. The sensor apparatus of claim 12, wherein the signal and detector electrode heaters are aligned with regions of the signal and detector electrode assemblies approximately adjacent to the signal and detector electrodes.

15. The sensor apparatus of claim 14, wherein the first and second spacers are offset from the signal and detector electrode heaters to facilitate heat transfer from the signal and detector electrode heaters to the signal and detector electrode assemblies.

16. The sensor apparatus of claim 1, wherein the signal electrode and the detector electrode are separated by a distance within a range of approximately 1 micrometer to approximately 1 centimeter.

17. The sensor apparatus of claim 1, wherein the signal electrode and the detector electrode are separated by a distance within a range of approximately 0.5 to 2.0 millimeters.

18. The sensor apparatus of claim 1, wherein the signal and detector electrodes of the signal and detector electrode assemblies are formed by a thick film formation process.

19. The sensor apparatus of claim 1, wherein the signal and detector electrodes of the signal and detector electrode assemblies are formed by a thin film formation process.

20. The sensor apparatus of claim 1, wherein the signal electrode insulating substrate and the detector electrode insulating substrate are bonded together with at least one insulating spacer between the signal electrode assembly and the detector electrode assembly.

21. The sensor apparatus of claim 20, wherein the signal electrode insulating substrate, the detector electrode insulating substrate, and the insulating spacer are sintered together.

22. A method comprising:
sensing an ambient condition with a signal electrode assembly comprising a signal electrode coupled to a signal ceramic substrate and a detector electrode assembly comprising a detector electrode coupled to a detector ceramic substrate;
supplying power to a heater positioned relative to at least one electrode assembly of the signal and detector electrode assemblies; and
heating one or more of the signal and detector electrode assemblies to a temperature greater than a burn threshold of a contaminating particulate matter on the one or more of the signal and detector electrode assemblies.

23. The method of claim 22, wherein sensing the ambient condition further comprises applying a bias voltage to one of the signal and detector electrodes, wherein the bias voltage comprises a voltage within a range of approximately 1 to 10,000 Volts relative to the other electrode of the signal and detector electrodes.

24. The method of claim 23, wherein the bias voltage comprises a voltage within a range of approximately 100 to 2,000 Volts relative to the other electrode of the signal and detector electrodes.

25. The method of claim 22, wherein heating the one or more of the signal and detector electrodes further comprises heating the one or more of the signal and detector electrodes to a temperature above approximately 200° Celsius to remove the contaminating particulate matter from the one or more signal and detector electrode assemblies.

26. The method of claim 25, further comprising continuously heating the one or more of the signal and detector electrodes.

27. The method of claim 25, further comprising periodically heating the one or more of the signal and detector electrodes.

28. The method of claim 22, further comprising detecting an accumulated charge on at least one electrode of the sensing and detecting electrodes.

29. The method of claim 22, further comprising detecting a current across a resistor coupled to the signal and detector electrodes.

30. The method of claim 22, further comprising controlling a heat source for heating the one or more of the signal and detector electrode assemblies, wherein the heat source control is responsive to a measurement of the contaminating particulate matter detected by the first and second electrode assemblies.

31. A method comprising:
coupling a signal electrode to a signal electrode insulating substrate to form a signal electrode assembly;
coupling a detector electrode to a detector electrode insulating substrate to form a detector electrode assembly, wherein the detector electrode is positioned relative to the signal electrode to generate a measurement of an ambient condition; and
positioning a heater relative to the signal and detector electrode assemblies to burn off an accumulation of contaminating particulate matters from at least one electrode assembly of the signal and detector electrode assemblies.

32. The method of claim 31, wherein at least one insulating substrate of the signal and detector insulating substrates comprises a ceramic substrate.

33. The method of claim 31, further comprising:
coupling the heater to a heater substrate; and
bonding the heater and the heater substrate to at least one electrode assembly of the signal and detector electrode assemblies.

34. The method of claim 33, wherein bonding the heater and the heater substrate further comprises sintering the heater and the heater substrate to the at least one electrode assembly of the signal and detector electrode assemblies.

35. The method of claim 33, further comprising positioning the heater substrate between the signal and detector electrode assemblies.

36. The method of claim 35, further comprising aligning the heater with regions of the signal and detector electrode assemblies approximately adjacent to the signal and detector electrodes.

37. The method of claim 33, further comprising positioning spacers between the heater substrate and the signal and detector electrode assemblies, wherein the spacers comprise insulating substrates to prevent electrical contact between the heater and the signal and detector electrode assemblies.

38. The method of claim 31, further comprising forming the heater on at least one electrode assembly of the signal and detector electrode assemblies.

39. The method of claim 31, further comprising forming the signal and detector electrodes and the heater using a thin film formation process.

40. The method of claim 31, further comprising forming the signal and detector electrodes and the heater using a thick film formation process.

41. The method of claim 31, further comprising coupling the heater to an electronic control module.

42. A sensing system to measure particulate matter, the sensing system comprising:
a sensor element comprising:
a signal electrode assembly with a signal electrode coupled to a signal electrode insulating substrate; and
a detector electrode assembly with a detector electrode coupled to a detector electrode insulating substrate, wherein the detector electrode is configured in combination with the signal electrode to generate an electrical signal in response to detection of particulate matter in a passing airstream;
a heater positioned relative to the sensor element to burn off an accumulation of contaminating particulate matters on the sensor element; and
an electronic control module coupled to the heater, the electronic control module to regulate a temperature of the heater relative to a burn threshold of the contaminating particulate matters on the sensor element.

43. The sensing system of claim 42, wherein at least one insulating substrate of the signal and detector insulating substrates comprises a ceramic substrate.

44. The sensing system of claim 42, wherein the electronic control module comprises:
an electronic memory device to store a lookup table of a plurality of particulate matter values indexed by a corresponding plurality of values of the electrical signal; and
a processor coupled to the electronic memory device, the processor to reference the lookup table in the electronic memory device to determine a measurement of the particulate matter in the passing airstream.

45. The sensing system of claim 44, wherein the electronic memory device is further configured to store machine readable instructions that, when executed by the processor, cause the electronic control module to compute the measurement of the particulate matter in the passing airstream based on a value of the electrical signal.

46. The sensing system of claim 44, further comprising a heater controller coupled to the processor and the heater, wherein the electronic memory device is further configured to store machine readable instructions that, when executed by the processor, cause the heater controller to regulate the temperature of the heater relative to the burn threshold of the contaminating particulate matters on the sensor element.

47. A sensor apparatus comprising:
a signal electrode assembly comprising a signal electrode coupled to a signal electrode insulating ceramic substrate;
a detector electrode assembly comprising a detector electrode coupled to a detector electrode insulating ceramic substrate, wherein the detector electrode is positioned relative to the signal electrode to generate a measurement of an ambient condition; and a
voltage supply in communication with at least one of the signal and detector electrodes, wherein the voltage supply is configured to apply a bias voltage to one of the signal and detector electrodes, wherein the bias voltage comprises a voltage within a range of approximately 50 to 10,000 Volts relative to the other electrode of the signal and detector electrodes.
